(19) United States
(12) Patent Application Publication
(10) Pub. No.: US 2026/0217375 A1
(43) Pub. Date: Jul. 30, 2026

(54) AIRCRAFT PROPULSION SYSTEM COMPRISING A TURBOMACHINE, A MOUNTING PYLON AND MEANS FOR ATTACHING THE TURBOMACHINE TO THE MOUNTING PYLON

(71) Applicant: Airbus Operations SAS, TOULOUSE (FR)

(72) Inventors: Olivier PAUTIS, TOULOUSE (FR); Lionel SILLIERES, TOULOUSE (FR); Simon VANDERBAUWEDE, TOULOUSE (FR); Nicolas CHARTON, TOULOUSE (FR); Julien VINOT, TOULOUSE (FR)

(21) Appl. No.: 19/459,165

(22) Filed: Jan. 26, 2026

(30) Foreign Application Priority Data
Jan. 28, 2025 (FR) FR2500876

(51) Int. Cl. B64D 27/40; B64D 27/12

(52) U.S. Cl. CPC B64D 27/402; B64D 27/12

(57) ABSTRACT

An aircraft propulsion system with a turbomachine having a front casing with a rear face and a rear casing, a mounting pylon with a front portion and to which a rear fitting is attached, an arch attached to the rear fitting and to the rear casing, and on each side of the vertical median plane, three port/starboard connecting rods, each connecting rod being attached between the rear face of the front casing and the arch, the three port connecting rods converging towards each other in a port convergence zone at the arch, and the three starboard connecting rods converging towards each other in a starboard convergence zone at the arch.

### CROSS-REFERENCES TO RELATED APPLICATIONS

This application claims the benefit of French Patent Application Number FR2500876 filed on Jan. 28, 2025, the entire disclosure of which is incorporated herein by way of reference.

### FIELD OF THE INVENTION

The present invention relates to the general field of attaching a turbomachine beneath the wing of a plane. This notably concerns a propulsion system comprising a turbomachine, such as a turbofan or a turboprop with a non-ducted fan, a mounting pylon and means for attaching the turbomachine beneath the mounting pylon. It also applies to an aircraft equipped with such a propulsion system.

### BACKGROUND OF THE INVENTION

A propulsion system of the prior art is attached beneath the wing of an aircraft. It comprises a turbomachine and a mounting pylon via which the turbomachine is attached beneath the wing. The mounting pylon has a rigid structure, which is also referred to as the primary structure, with attachment means for attaching the turbomachine.

These attachment means are made up, among other things, of a front attachment for the turbomachine, of a rear attachment for the turbomachine and of a device for reacting the thrust forces generated by the turbomachine.

The mounting pylon also has other attachment elements for attaching the mounting pylon to the wing.

Although such a structure is satisfactory, it is desirable to find an alternative arrangement which makes it possible, among other things, to establish an isostatic connection between the turbomachine and the mounting pylon, while at the same time choosing the most suitable force paths.

### SUMMARY OF THE INVENTION

An object of the present invention is to propose a propulsion system comprising a turbomachine, a mounting pylon and means for attaching the turbomachine beneath the mounting pylon.

To this end, a propulsion system for an aircraft is proposed, said propulsion system comprising:
a turbomachine extending around a longitudinal axis and having a vertical median plane containing the longitudinal axis and comprising a front casing with a rear face perpendicular to the longitudinal axis and a rear casing,
a mounting pylon having a rigid structure with a front portion and a lower spar to which a rear fitting is attached,
a front engine mount which is attached between an upper portion of the front casing and the front portion of the rigid structure,
an arch with a base hinged to the rear fitting and two arms arranged one on each side of the vertical median plane, each arm having a first end secured to the base and a second end hinged to the rear casing,
on a port side of the vertical median plane, three port connecting rods, each port connecting rod being attached to the rear face of the front casing via a first port connecting point and to the arch via a second port connecting point, the three port connecting rods converging towards each other in a port convergence zone at the arch, and
on a starboard side of the vertical median plane, three starboard connecting rods, each starboard connecting rod being attached to the rear face of the front casing via a first starboard connecting point and to the arch via a second starboard connecting point, the three starboard connecting rods converging towards each other in a starboard convergence zone at the arch.

Such an arrangement makes it possible, among other things, to establish an isostatic connection between the turbomachine equipped with attachment elements and the mounting pylon.

Advantageously, the rear fitting and the arch lie in a single plane of integration perpendicular to the longitudinal axis.

Advantageously, each convergence zone is located, parallel to the longitudinal axis, at a maximum distance equal to three times the thickness of the arch either in front of the plane of integration or behind the plane of integration.

Advantageously, the port convergence zone and the starboard convergence zone are symmetrical with respect to the vertical median plane.

Advantageously, the port convergence zone is between 10 o'clock and 11 o'clock, and the starboard convergence zone is between 1 o'clock and 2 o'clock.

Advantageously, for each group of three connecting rods, there is a lower connecting rod whose first connecting point is between 7 o'clock and 9 o'clock, respectively between 3 o'clock and 5 o'clock, and, for each group of three connecting rods, there are two upper connecting rods whose first connecting point is between 10 o'clock and 12 o'clock, respectively between 12 o'clock and 2 o'clock.

Advantageously, the second connecting point of at least one connecting rod of each group of three connecting rods takes the form of an encastre connection with the arch.

Advantageously, the base and the rear fitting are attached to each other not only by two rear connecting rods arranged symmetrically one on each side of the vertical median plane, each rear connecting rod being hinged to the rear fitting via a first connecting point and to the base via a second connecting point, but also, on the vertical median plane, via a third connecting point connecting the base and the rear fitting.

Advantageously, the rear connecting rods lie in the plane of integration.

Advantageously, the second end of each arm and the rear casing are attached to each other by two pairs of link rods arranged symmetrically for each pair, with one pair on each side of the vertical median plane, each link rod lying in a plane perpendicular to the longitudinal axis, and each link rod being hinged to the second end of the arm that is on the same side via a first connecting point and to the rear casing via a second connecting point.

Advantageously, the link rods lie in the plane of integration.

Advantageously, for each pair of link rods, the two link rods are arranged symmetrically one on each side of a horizontal plane passing through the longitudinal axis.

Advantageously, the front engine mount has a front fitting attached to the front portion, two front connecting rods arranged symmetrically one on each side of the vertical median plane, and a vertical pin secured to the front fitting or to the front casing and fitted in a bore in the front casing or in the front fitting, respectively, each front connecting rod being hinged to the front fitting via a first connecting point and to the front casing via a second connecting point.

The invention relates to an aircraft comprising a propulsion system according to any of the preceding variants.

### BRIEF DESCRIPTION OF THE DRAWINGS

The above-mentioned features of the invention, along with others, will become more clearly apparent upon reading the following description of an exemplary embodiment, said description being given with reference to the appended drawings, in which:

FIG. 1 is a side view of an aircraft according to the invention,

FIG. 2 is a schematic perspective representation of a propulsion system according to the invention,

FIG. 3 is a sectional view along section plane III in FIG. 2, and

FIG. 4 is a sectional view along section plane IV in FIG. 2.

### DETAILED DESCRIPTION OF THE PREFERRED EMBODIMENTS

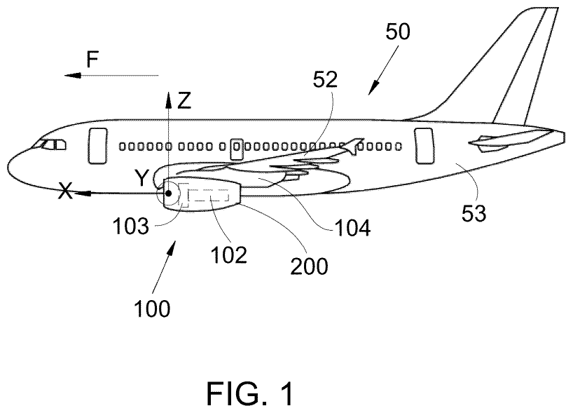

FIG. 1 shows an aircraft 50 that has a fuselage 53 on each side of which a wing 52 is attached. Attached beneath each wing 52 is a propulsion system 100 according to the invention, the propulsion system comprising a mounting pylon 104 and a turbomachine 102 which in this case is accommodated in a nacelle 200. The invention applies to any type of turbomachine 102, such as, for example, a turbofan or a turboprop with a non-ducted fan.

The propulsion system 100 is attached to the wing 52 by the mounting pylon 104 and the turbomachine 102 is attached beneath the mounting pylon 104.

By convention, X denotes the longitudinal axis of the turbomachine 102, this axis X being parallel to a longitudinal direction of this turbomachine 102 and to a longitudinal direction of the aircraft 50. Additionally, Y is the transverse axis of the turbomachine 102, this axis being horizontal when the aircraft 50 is on the ground, and Z is the vertical axis or vertical height when the aircraft 50 is on the ground, these three axes X, Y and Z being mutually orthogonal.

Furthermore, the terms “front” and “rear” are to be considered relative to a direction of forward movement of the aircraft 50 when the turbomachine 102 is operating, this direction being schematically shown by the arrow F.

The turbomachine 102 and the mounting pylon 104 are symmetrical overall with respect to a vertical median plane P (XZ) containing the longitudinal axis X and thus the vertical direction Z. The transverse axis Y is perpendicular to the vertical median plane P.

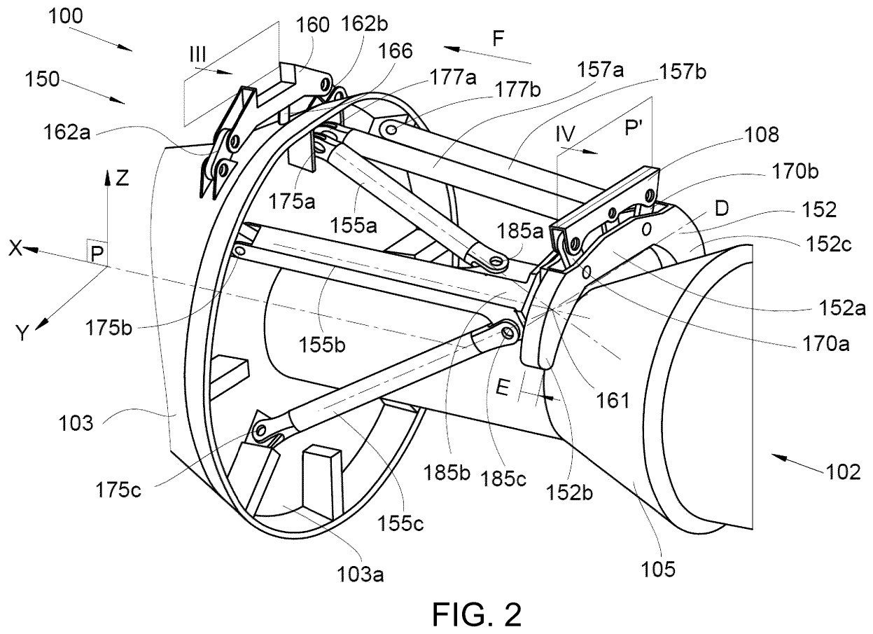

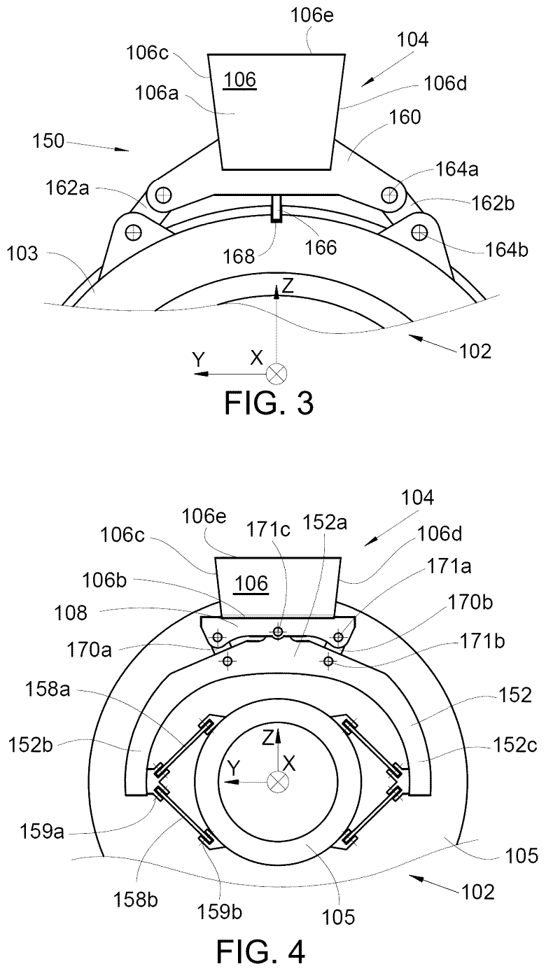

FIG. 2 shows the propulsion system 100 according to the invention and FIGS. 3 and 4 show embodiment details of the propulsion system 100.

The propulsion system 100 comprises the turbomachine 102 and the mounting pylon 104 which attaches the turbomachine 102 to the wing 52. The mounting pylon 104 is represented here by its rigid structure 106 (FIG. 3), also referred to as primary structure, that is attached to the structure of the wing 52 by any suitable securing means known to those skilled in the art.

The rigid structure 106 takes the form of a box which comprises a front portion 106a, located at the front of the rigid structure 106, a lower spar 106b extending below the rigid structure 106 and an upper spar 106e extending above the rigid structure 106. The rigid structure 106 also comprises two lateral walls 106c-d, one on each side of the vertical median plane P. These various spars and walls are attached to each other to form the rigid structure 106. The front portion 106a comprises for example a front wall and a portion of the lower spar 106b and of the lateral walls 106c-d.

The turbomachine 102 comprises the following, from front to rear: a front casing 103 and a rear casing 105 which is attached to the rear of the front casing 103 and which accommodates elements of the turbomachine 102, such as compression stages, a combustion chamber, turbine stages and an exhaust cone. The front casing 103 is for example a fan casing in which a fan of a jet engine is mounted, but may also be the casing which is just to the rear of the fan in the case of a turboprop with a non-ducted fan.

The front casing 103 has a diameter greater than the diameter of the rear casing 105.

At the rear, the front casing 103 has a rear face 103a which is perpendicular to the longitudinal axis X and thus extends in a plane parallel to the plane YZ. The front casing 103 and the rear casing 105 form surfaces of revolution about the longitudinal axis X.

The propulsion system 100 comprises a front engine mount 150 which attaches an upper portion of the front casing 103 to the front portion 106a of the rigid structure 106.

The propulsion system 100 also comprises an arch 152 arranged around the rear casing 105 and to the rear of the rear surface 103a of the front casing 103.

A rear fitting 108 is rigidly attached to the lower spar 106b beneath the rigid structure 106.

The arch 152 has a base 152a which is hinged to the rear fitting 108. The arch 152 also has two arms 152b-c arranged one on each side of the vertical median plane P, i.e., symmetrically with respect to the vertical median plane P; there is a port-side arm 152b and a starboard-side arm 152c. Each arm 152b-c has a first end secured to the base 152a and a second end hinged to the rear casing 105. Each arm 152b-c may be an element attached to the base 152a or form a one-piece assembly with the base 152a.

In the embodiment of the invention shown in FIG. 2, the two ends of each arm 152b-c of the arch 152 are respectively at 3 o'clock and 9 o'clock when viewed from behind. However, the positions of the second ends of each arm 152b-c of the arch 152 may be arranged at +/−45° with respect to these positions shown. The arch 152 has, parallel to the longitudinal axis X, a thickness E which is dimensioned so as to withstand the forces passing through it as in the rear attachments of the prior art. The thickness E is distributed on either side of a plane of integration P′.

The propulsion system 100 also comprises, on the port side of the vertical median plane P, three port connecting rods 155a-c and, on the starboard side of the vertical median plane P, three starboard connecting rods 157a-b, only two of which are visible in FIG. 2. The port connecting rods 155a-c and the starboard connecting rods 157a-b are symmetrical overall with respect to the vertical median plane P.

Each port connecting rod 155a-c is attached by one of its ends to the rear face 103a of the front casing 103 via a first port connecting point 175a-c and by the other of its ends to the arch 152 via a second port connecting point 185a-c. The three port connecting rods 155a-c converge towards each other in a port convergence zone 161 which is at the level of the arch 152.

In the embodiment of the invention shown here, the port convergence zone 161 is here a point of intersection, but it can be more extensive.

In other words, according to the invention, the three port connecting rods 155a-c converge towards each other in the port convergence zone 161 which is at the level of the arch 152 when, parallel to the longitudinal axis X, the port convergence zone 161 is located at a maximum distance equal to three times the thickness of the arch 152 either in front of the plane of integration P′ or behind the plane of integration P′.

Each starboard connecting rod 157a-c is attached by one of its ends to the rear face 103a of the front casing 103 via a first starboard connecting point 177a-b and by the other of its ends to the arch 152 via a second starboard connecting point (not visible in FIG. 2).

The three starboard connecting rods 157a-b converge towards each other in a starboard convergence zone which is at the level of the arch 152.

As above, the starboard convergence zone is preferably a point of intersection, but it can be more extensive.

In other words, according to the invention, the three starboard connecting rods 157a-c converge towards each other in the starboard convergence zone which is at the level of the arch 152 when, parallel to the longitudinal axis X, the starboard convergence zone is located at a maximum distance equal to three times the thickness of the arch 152 either in front of the plane of integration P′ or behind the plane of integration P′.

Such a propulsion system 100 thus makes it possible to establish an isostatic connection between the turbomachine and the mounting pylon by way of various attachment elements.

The zone at which the axes of the connecting rods 155a-c, 157a-b cross is referred to as the convergence zone 161.

In the embodiment of the invention shown in FIG. 2, the rear fitting 108 and the arch 152 lie in the single mean plane of integration P′ which is perpendicular to the longitudinal axis X.

The port convergence zone 161 and the starboard convergence zone are aligned on a line of convergence D which is perpendicular to the vertical median plane P; in other words, the convergence zones 161 are symmetrical with respect to the vertical median plane P. Due to the potential spatial extent of the convergence zones, the line of convergence D is a mean line connecting, for example, the barycenters of the two convergence zones.

The convergence zones 161 are close to the arch 152, thereby limiting the transmission of out-of-plane forces and unwanted torques at the arch 152.

According to a general embodiment, when viewed from behind, the port convergence zone 161 is between 10 o'clock and 11 o'clock, and the starboard convergence zone is between 1 o'clock and 2 o'clock.

In general, and when viewed from behind, for each group of three connecting rods 155a-c, 157a-b, there is a lower connecting rod 155c whose first connecting point 175 c is between 7 o'clock and 9 o'clock on the port side, and between 3 o'clock and 5 o'clock on the starboard side. Furthermore, for each group of three connecting rods 155a-c, 157a-b, there are two upper connecting rods 155a-b, 157a-b whose first connecting point 175 a-b is between 10 o'clock and 12 o'clock on the port side, and between 12 o'clock and 2 o'clock on the starboard side.

Preferably, in order to limit rotations about an axis perpendicular to the longitudinal axis X and in particular about the line of convergence D, the second connecting point 185b of at least one connecting rod 155b, 157b of each group of three connecting rods 155a-c, 157a-b takes the form of an encastre connection with the arch 152. Here, it is one of the upper connecting rods 155b, 157b which is connected in encastre fashion to the arch 152. There is only one encastre connecting point here, but it is possible to have more.

Each of the other connecting points at the arch 152 and the front casing 103 takes the form of a ball-joint connection for limiting the bending moments, but it can also take the form of an encastre connection.

Each connecting point 175a-c, 177a-b, 185a, 185c which is not embedded in encastre fashion takes the form of a clevis connection in this case. Each encastre connection is achieved, for example, by welding, force-fitting, clamping using a screw-nut system, etc.

FIG. 4 more clearly shows an example of the attachment between the base 152a of the arch 152 and the rear fitting 108. This attachment is realized by two rear connecting rods 170a-b and by a third connecting point 171c which is a backup connecting point, that is to say it only activates if one of the rear connecting rods 170a-b fails.

The two rear connecting rods 170a-b are arranged symmetrically one on each side of the vertical median plane P and each rear connecting rod 170a-b is hinged to the rear fitting 108 via a first connecting point 171a and to the base 152a via a second connecting point 171b. Each connecting point 171a-b connected to the rear connecting rods 170a-b takes at least the form of a pivot connection, but preferably takes the form of a ball-joint connection for limiting the bending moments and each connecting point in this case has a main axis of rotation which is parallel to the longitudinal axis X.

The third connecting point 171c connects the base 152a to the rear fitting 108 and is arranged on the vertical median plane P. This third connecting point 171c takes at least the form of a pivot connection, but preferably takes the form of a ball-joint connection for limiting the bending moments and in this case has a main axis of rotation which is parallel to the longitudinal axis X.

In the embodiment of the invention shown here, the rear connecting rods 170a-b lie in the plane of integration P′. Each connecting point 171a-c takes the form of a clevis connection in this case.

In the case of the third connecting point 171c, the pin of the clevis connection has a diameter slightly less than the diameter of the bores in which it is fitted such that it only comes into contact with said bores when necessary.

FIG. 4 also shows a particular embodiment of the attachment between the second end of each arm 152b-c and the rear casing 105. This attachment is realized by two pairs of link rods 158a-b, the pairs being arranged symmetrically one on each side of the vertical median plane P and each link rod 158a-b lying in a plane perpendicular to the longitudinal axis X which is also the plane in which the arch 152 lies.

Each link rod 158a-b is hingedly and removably attached to the second end of the arm 152b-c that is on the same side via a first connecting point 159a and to the rear casing 105 via a second connecting point 159b.

In this case, for each pair of link rods 158a-b, the two link rods 158a-b are arranged symmetrically one on each side of a horizontal plane passing through the longitudinal axis X, that is to say the plane XY. The symmetrical fitting in place makes it possible to position the rear casing 105 relative to the arch 152.

Each connecting point 159a-b connected to the link rods 158a-b takes at least the form of a pivot connection, but preferably takes the form of a ball-joint connection for limiting the bending moments and each of these connecting points 159a-b in this case has a main axis of rotation which is perpendicular to the axis of the link rod 158a-b in question and lies in a plane which is perpendicular to the longitudinal axis X and is also the plane in which the arch 152 lies.

Each connecting point 159a-b takes the form of a clevis connection in this case.

In the embodiment of the invention shown here, the link rods 158a-b lie in the plane of integration P′.

FIG. 3 more clearly shows an example of a front engine mount 150 implemented in the invention, but the engine mount 150 can have a different architecture.

The front engine mount 150 has a front fitting 160 attached to the front portion 106a and two front connecting rods 162a-b arranged symmetrically one on each side of the vertical median plane P. Each front connecting rod 162a-b is hinged to the front fitting 160 via a first connecting point 164a and to the front casing 103 via a second connecting point 164b. Each connecting point 164a-b connected to the front connecting rods 162a-b takes at least the form of a pivot connection, but preferably takes the form of a ball-joint connection for limiting the bending moments and each connecting point in this case has a main axis of rotation which is parallel to the longitudinal axis X. Each connecting point 164a-b takes the form of a clevis connection in this case.

The front engine mount 150 also has a connection of the “spigot” type with a pin 166 which extends vertically, that is to say parallel to the vertical axis Z, and lies in the vertical median plane P.

The pin 166 is secured to the front fitting 160 or to the front casing 103 and is fitted, as the case may be, in a bore 168 in the front casing 103 or in the front fitting 160.

The fit between the bore 168 and the pin 166 is such that there is no movement along the longitudinal axis X or along the transverse axis Y and there are only movements along the vertical axis Z.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A propulsion system for an aircraft, the propulsion system comprising:
a turbomachine extending around a longitudinal axis and having a vertical median plane containing the longitudinal axis and comprising a front casing with a rear face perpendicular to the longitudinal axis and a rear casing;
a mounting pylon having a rigid structure with a front portion and a lower spar to which a rear fitting is attached;
a front engine mount attached between an upper portion of the front casing and the front portion of the rigid structure;
an arch with a base hinged to the rear fitting and two arms arranged one on each side of the vertical median plane, each arm having a first end secured to the base and a second end hinged to the rear casing;
on a port side of the vertical median plane, three port connecting rods, each port connecting rod attached to the rear face of the front casing via a first port connecting point and to the arch via a second port connecting point, the three port connecting rods converging towards each other in a port convergence zone at the arch; and
on a starboard side of the vertical median plane, three starboard connecting rods, each starboard connecting rod being attached to the rear face of the front casing via a first starboard connecting point and to the arch via a second starboard connecting point, the three starboard connecting rods converging towards each other in a starboard convergence zone at the arch.

2. The propulsion system according to claim 1, wherein the rear fitting and the arch lie in a single plane of integration perpendicular to the longitudinal axis.

3. The propulsion system according to claim 2, wherein each convergence zone is located, parallel to the longitudinal axis, at a maximum distance equal to three times a thickness of the arch either in front of the single plane of integration or behind the single plane of integration.

4. The propulsion system according to claim 1, wherein the port convergence zone and the starboard convergence zone are symmetrical with respect to the vertical median plane.

5. The propulsion system according to claim 1, wherein the port convergence zone is between 10 o'clock and 11 o'clock, and
wherein the starboard convergence zone is between 1 o'clock and 2 o'clock.

6. The propulsion system according to claim 1, wherein, for each group of three connecting rods, there is a lower connecting rod with a first connecting point between 7 o'clock and 9 o'clock and between 3 o'clock and 5 o'clock, and
wherein, for each group of three connecting rods, there are two upper connecting rods with a first connecting point i between 10 o'clock and 12 o'clock and between 12 o'clock and 2 o'clock.

7. The propulsion system according to claim 1, wherein a second connecting point of at least one connecting rod comprises an encastre connection with the arch.

8. The propulsion system according to claim 1, wherein the base and the rear fitting are attached to each other by:
two rear connecting rods arranged symmetrically one on each side of the vertical median plane, each rear connecting rod hinged to the rear fitting via a first connecting point and to the base via a second connecting point, and
on the vertical median plane, via a third connecting point connecting the base and the rear fitting.

9. The propulsion system according to claim 8, wherein the rear fitting and the arch lie in a single plane of integration perpendicular to the longitudinal axis,
wherein the rear connecting rods lie in the single plane of integration.

10. The propulsion system according to claim 1, wherein the second end of each arm and the rear casing are attached to each other by two pairs of link rods arranged symmetrically for each pair, with one pair on each side of the vertical median plane, each link rod lying in a plane perpendicular to the longitudinal axis, and each link rod hinged to the second end of an arm on a same side via a first connecting point and to the rear casing via a second connecting point.

11. The propulsion system according to claim 10, wherein the rear fitting and the arch lie in a single plane of integration perpendicular to the longitudinal axis, and
wherein the link rods lie in the single plane of integration.

12. The propulsion system according to claim 10, wherein, for each pair of link rods, the two link rods are arranged symmetrically one on each side of a horizontal plane passing through the longitudinal axis.

13. The propulsion system according to claim 1, wherein the front engine mount has a front fitting attached to the front portion, two front connecting rods arranged symmetrically one on each side of the vertical median plane, and a vertical pin secured to the front fitting or to the front casing and fitted in a bore in the front casing or in the front fitting, respectively, each front connecting rod being hinged to the front fitting via a first connecting point and to the front casing via a second connecting point.

14. An aircraft comprising:
the propulsion system according to claim 1.
